(19) United States
(12) Patent Application Publication
(10) Pub. No.: US 2010/0159302 A1
(43) Pub. Date: Jun. 24, 2010

(54) SOLID-OXIDE FUEL CELL WITH FERRITIC SUPPORT

(75) Inventors: Ander Laresgoiti Rementeria, Iurreta (Bizkaia) (ES); Igor Villarreal Sarria, Bilbao (Bizkaia) (ES); Lide Mercedes Rodriguez Martinez, Arrasate-Mondragon (Gipuzkoa) (ES)

Correspondence Address: Berenbaum Weinshienk PC, 370 Seventeenth Street, Republic Plaza, Suite 4800, Denver, CO, 80202, US

(73) Assignee: IKERLAN, S. COOP., Arrasate (Gipuzkoa) (ES)

(21) Appl. No.: 12/642,636

(22) Filed: Dec. 18, 2009

(30) Foreign Application Priority Data
Dec. 19, 2008 (ES) P200803627

(51) Int. Cl. H01M 8/10

(52) U.S. Cl. 429/31

(57) ABSTRACT

A solid oxide fuel cell having a tubular metal support an open end. A first electrode is deposited on the metal support, an electrolyte is deposited on the first electrode, and a second electrode is deposited on the electrolyte. The open end of the metal support is in communication with a fuel supply and attached to an external structure of the fuel supply by threads.

### CROSS-REFERENCE TO RELATED APPLICATIONS

This application claims priority to and the benefit of Spanish Patent Application No. P200803627, filed Dec. 19, 2008.

### TECHNICAL FIELD

This invention relates to solid oxide fuel cells.

### BACKGROUND

There are known solid oxide fuel cells which produce electricity directly from fuels by electrochemically combining them with an oxidant, both being in a gaseous state. Each solid oxide fuel cell comprises a first electrode acting as an anode, a second electrode acting as a cathode, with both the anode and the cathode comprising porous materials, and an electrolyte that comprises an ionically conducting material.

A supply system supplies the fuel, preferably to the anode, while the oxidant is supplied to the cathode. In addition, the electrolyte is an electronic insulator that enables the transport of oxygen ions or protons between the two electrodes. The oxidation reaction thus occurs in the anode, with electrons being released to the external circuit and reaching the cathode, thereby generating an electrical current and the known reduction reaction taking place. Generally, the fuel normally used is hydrogen due to its high electrochemical reactivity and to the fact that it may be obtained with relative ease from hydrocarbons, alcohol and even from water. Regarding the oxidant, oxygen is the most widely used as it is found in the air and is therefore easy to obtain.

The solid oxide fuel cells operate at high temperatures within an approximate range of 600 to 1000° C., and may have a flat or tubular shape, the latter presenting greater mechanical strength and being easier to seal at the ends. In addition, depending on the type of support used in tubular solid oxide fuel cells, there are solid oxide fuel cells with a cathodic support, anodic support, electrolyte support or a metal support.

In general terms, a solid oxide fuel cell is arranged connected at one of its ends to the fuel supply system, while the other end is arranged connected to a system evacuating excess fuel and water, both of which are products of the chemical reaction occurring in the solid oxide fuel cell. It is essential that both ends are sealed properly to the fuel-supply and evacuation systems to ensure that the solid oxide fuel cell performs optimally. Bearing in mind the high operating temperatures to which solid oxide fuel cells are subjected, the materials from which the cell is made, or the arrangement of electrical connectors through which electricity is extracted from the cell result in the sealing not being a simple task.

U.S. Pat. No. 7,374,835 B2 describes a solid oxide fuel stack that includes tubular cells with an electrolytic support in which the electrolyte and the anode project out in relation to the cathode, the ends of which have fixing members that are fixed tightly to the electrolyte by means of a suitable sealant, cement or a ceramic seal.

U.S. Patent Application Publication No. 2007/0231660 A1 describes a sealing member and a method for sealing the ends of a tubular solid oxide fuel cell with an anodic support in which the sealing member includes a pipe that has a first segment in which the solid oxide cell is housed tightly, and a second segment, continuous to the first segment, that includes a pipe through which fuel enters the fuel cell. The fuel cell has an anode and an electrolyte that project out in relation to the cathode, with the anode and the electrolyte deposited on the anode being housed tightly in the first segment of the sealing member. In order to fix the sealing member to the fuel cell, the external surface of the electrolyte that projects out in relation to the cathode must be covered with a layer of metallic sealant, without the sealant touching the cathode, the electrolyte covered with the layer of sealant must subsequently be inserted into the inside of the sealing member, and the connection must be heated until the layer of sealant melts and solidifies.

### SUMMARY OF THE DISCLOSURE

An object of the invention is to provide a tubular solid oxide fuel adapted to be fixed to a fuel or gas supply system.

A tubular solid oxide fuel cell according to one implementation comprises a first electrode, an electrolyte deposited on the first electrode, and a second electrode deposited on the electrolyte, with the tubular solid oxide fuel cell having at least one open end.

In one implementation, the tubular solid oxide fuel cell comprises a metal support on which is deposited the first electrode, and which includes at least a threaded first end through which the tubular solid oxide fuel cell is tightly fixed to the supply system. As a result, the tightness of the fixing, the structural stability and the electrical conductivity is improved during its operation.

These and other advantages and characteristics of the invention will be made evident in the light of the drawings and the detailed description thereof.

### BRIEF DESCRIPTION OF THE DRAWINGS

FIG. 1 is a schematic cross-sectional view of an embodiment of a tubular solid oxide fuel cell according to the invention, built into a fuel stack.

FIG. 2 is a detail of a cross-section of the sealing of the tubular solid oxide fuel cell shown in FIG. 1, and the fixing to a supply system.

FIG. 3 is a detail of a cross-section of the sealing of the tubular solid oxide fuel cell shown in FIG. 1, and the fixing to an evacuation system.

FIG. 4 is a detail of a cross-section of the sealing and the fixing to a supply system of a second embodiment of a tubular solid oxide fuel cell.

### DETAILED DESCRIPTION

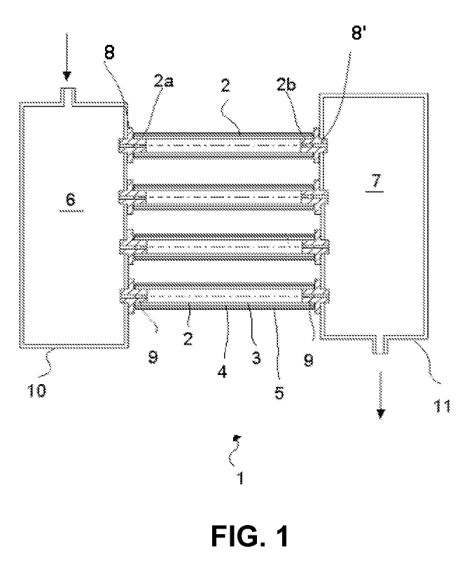

FIG. 1 illustrates a solid oxide fuel cell stack according to one implementation that comprises tubular solid oxide fuel cells 1, each one of which is connected to a fuel supplying system 6 and to an evacuating system 7 for the remaining fuel. The tubular solid oxide fuel cell 1 comprises a metal support 2, a first electrode 3 deposited on the metal support 2, an electrolyte 4 deposited on the first electrode 3, and a second electrode 5 deposited on the electrolyte 4.

The first electrode 3 is the anode and the second electrode 5 is the cathode. The first electrode 3 comprises Ni-YSZ or an equivalent ceramic material such as Ni-ScsZ, Ni-YDC or Ni-SDC, the electrolyte 4 comprises YSZ or an equivalent material such as Ssz, YDC o SDC, and the cathode comprises lightly doped lanthanum manganite or an equivalent material. The metal support 2 is preferably made of a ferritic alloy, though it may also be made of an austenitic alloy, nickel alloys or equivalent alloys.

In the embodiment shown in FIGS. 1 to 3, the tubular solid oxide fuel cell 1 has both ends open, a first end being connected to the supply system 6 so that it may be supplied with fuel, preferably hydrogen, while a second end is connected to the evacuation system 7 through which remaining fuel is collected along with fuel in the event that the fuel used is hydrogen, the remaining fuel and the water being products of the known chemical reaction occurring in the tubular solid oxide fuel cell 1. In other embodiments, the tubular solid oxide fuel cell 1 may be supplied with hydrocarbons, as a result of which internal alterations must be made.

The supply system 6 comprises an external structure 10, and the evacuation system 7, for its part, comprises an external support 11, the first end of the tubular solid oxide fuel cell 1 being fixed to the external structure 10 and the second end to the external support 11, each of them through a respective connection member 8, 8′.

The connection members 8, 8′ seal the corresponding end of the tubular solid oxide fuel cell 1, fixing it to the external structure 10 or to the external support 11 respectively, the metal support 2 of the tubular solid oxide fuel cell 1 including for that a corresponding internal thread 9 in a first end 2a and in a second end 2b.

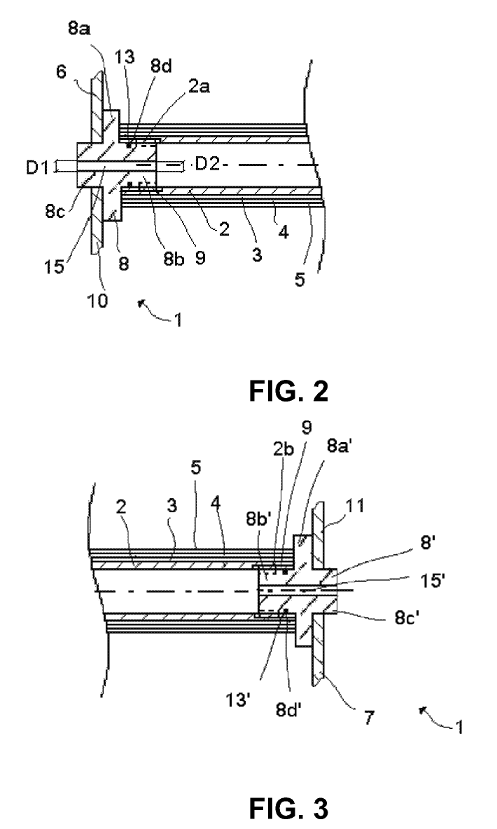

Each connection member 8, 8′, shown in detail in FIGS. 2 and 3, is substantially cylindrical and comprises a base 8a, 8a′ on which is supported the corresponding end of the metal support 2, a first segment 8b, 8b′ that extends continuously from one of the ends of the base 8a, 8a′ and which is housed inside the metal support 2, and a second segment 8c, 8c′ that extends continuously from the opposite end of the base 8a, 8a′, being fixed to the external structure 10 or the external support 11. The first segment 8b, 8b′ and the second segment 8c, 8c′ are preferably coaxial and threaded externally, with the result that the first segment 8b, 8b′ cooperates with the internal thread 9 of the end of the corresponding metal support 2 for the tight closure of the tubular solid oxide fuel cell 1.

In order to improve the sealing between the metal support 2 and the corresponding connection member 8, 8′, each connection member 8, 8′ comprises a housing 8d, 8d′ wherein a sealing joint 13, 13′ is inserted.

In addition, both the internal thread 9 of the metal support 2 and the external thread of the first segment 8b, 8b′ of the corresponding connection member 8, 8′ may be cylindrically or conically threaded.

Furthermore, each connection member 8, 8′ comprises a channel 15, 15′ that preferably passes concentrically through the corresponding connection member 8, 8′ and through which fuel is able to enter the inside of the metal support 2 from the supply system 6 or the remaining fuel is able to exit along with the water to the evacuation system 7. The channel 15 has an intake diameter D1 that is smaller than or equal to the outlet diameter D2, as shown in FIG. 2.

An advantage associated with the tubular solid oxide fuel cell 1 of the present invention is that the metal support 2 does not have to project out in relation to the rest of the components of the tubular solid oxide fuel cell 1, as occurs with the supports of known tubular cells, thus making them easier to manufacture.

Each connection member 8, 8′ is preferably made of a metallic conductor material that has a coefficient of thermal expansion similar to that of the metal support 2, with the result that the connection of the tubular solid oxide fuel cell 1 to the supply system 6 and the evacuation system 7 presents excellent structural stability when the tubular solid oxide fuel cell 1 reaches high operating temperatures. In addition, the high temperatures at which the tubular solid oxide fuel cell 1 operates leads to the creation of microwelds in the threaded connection of the corresponding connection member 8, 8′ to the metal support 2, leading to a permanent connection.

Additionally, one of the two connection members 8, 8′ assembled to the tubular solid oxide fuel cell 1 acts as a collector of the first electrode 3, while the other connection member 8′, 8 may act as a collector of the first electrode 3 or may be insulated (i.e., not act as a functional part of the solid oxide fuel cell to generate an electrical current).

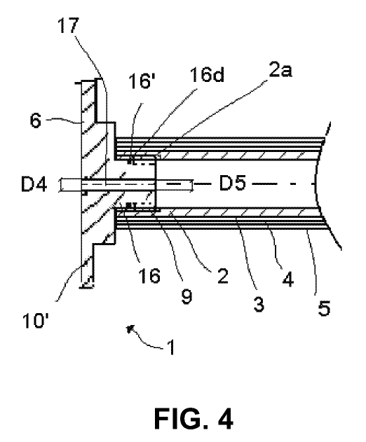

In another embodiment, as shown in FIG. 4, the metal support 2 is fixed directly to an external structure 10′ of the supply system 6, with the connection member of the previously described embodiment being arranged integrated into the external structure 10′. The external structure 10′ thus includes a threaded projecting part 16 that cooperates with the internal thread 9 of the metal support 2 for the sealing and fixing of the tubular solid oxide fuel cell 1 to the external structure 10′ of the supply system 6. The projecting part 16 comprises a channel 17 that preferably passes concentrically through the projecting part 16 and through which fuel is able to enter the inside of the metal support 2. The channel 17 has an intake diameter D4 that is smaller than or equal to the outlet diameter D5, as shown in FIG. 4.

The projecting part 16 may include a conical thread, and is made of a preferably metallic conductor material with similar characteristics to the connection member 8 of the previously described embodiment. The projecting part 16 also comprises a housing where a sealing joint 16′ is inserted and which improves the sealing against the tubular support 2.

Similarly, the metal support 2 is fixed directly to an external support of the evacuation system (not shown in FIG. 4), with the external support including a projecting part that cooperates with the internal thread 9 of the metal support 2 for the sealing and the fixing of the tubular solid oxide fuel cell 1 to the external support, and through which the remaining fuel exits along with the water to the evacuation system 7. The projecting part built into the external support has similar characteristics to the projecting part 16 built into the external structure 10′ of the evacuation system 6.

As in the previously described embodiment shown in FIGS. 2 and 3, one of the two projecting parts assembled in the tubular solid oxide fuel cell 1 acts as a collector of the first electrode 3, while the other projecting part may act as a collector of the first electrode 3 or may be arranged in an insulated manner.

In other embodiments not shown in the figures, the tubular solid oxide fuel cell 1 may have a single open end, through which the tubular solid oxide fuel cell 1 is fixed to a supply system and an evacuation system. In this case the corresponding connection member 8, 8 or the projecting part 16 act as collectors of the first electrode 3.

In other embodiments not shown in the figures, the metal support 2 comprises a threaded exterior on one end for its threaded fixing to the external structure 10, either directly or through an intermediate connection member.

What is claimed is:

1. A solid oxide fuel cell comprising:
a tubular metal support having an open first end and a second end,
a first electrode deposited on the metal support,
an electrolyte deposited on the first electrode,
a second electrode deposited on the electrolyte,
a fuel supply having an external structure, the first end of the metal support in communication with the fuel supply and connected to the external structure of the fuel supply by threads.

2. A solid oxide fuel cell according to claim 1, further comprising an evacuating system having an external structure, the second end of the tubular support being open and in communication with the evacuating system and attached to the external structure of the evacuating system.

3. A solid oxide fuel cell according to claim 2, wherein the open second end of the metal support is attached to the external structure of the evacuating system by threads.

4. A solid oxide fuel cell according to claim 1, further comprising a first connection member having a threaded first segment with a first set of external threads and a threaded second segment with a second set of external threads, the first end of the metal support and the external structure of the fuel supply each having a set of internal threads, the first connection member attached to the external structure of the fuel supply by the engagement of the first set of external threads with the internal threads of the external structure of the fuel supply, the first connection member attached to the first end of the metal support by the engagement of the second set of threads with the internal threads in the first end of the metal support.

5. A solid oxide fuel cell according to claim 4, further comprising an evacuating system having an external structure, the second end of the metal support being open and in communication with the evacuating system, the solid oxide fuel cell comprising a second connection member having a first set of external threads and a second set of external threads, the second end of the metal support and the external structure of the evacuating system each having a set of internal threads, the second connection member attached to the external structure of the evacuating system by the engagement of the first set of external threads with the internal threads of the external structure of the evacuating system, the second connection member attached to the second end of the metal support by the engagement of the second set of threads with the internal threads in the second end of the metal support.

6. A solid oxide fuel cell according to claim 4, wherein the first connection member comprises a base on which the metal support is supported, the threaded first segment and threaded second segment each being continuous to the base.

7. A solid oxide fuel cell according to claim 4, wherein the first connection member comprises a supply channel that passes through the first connection member and through which fuel is injected into the metal support.

8. A solid oxide fuel cell according to claim 7, wherein the supply channel has an intake diameter and an outlet diameter, the intake diameter being greater than the outlet diameter.

9. A solid oxide fuel cell according to claim 4, wherein the first connection member is metallic.

10. A solid oxide fuel cell according to claim 4, wherein the first connection member acts as a collector of the first electrode.

11. A solid oxide fuel cell according to claim 4, wherein the first connection member is insulated.

12. A solid oxide fuel cell according to claim 1, wherein the external structure of the fuel supply comprises a projecting part having external threads and the first end of the metal support comprises internal threads, the first end of the metal support connected to the external structure of the fuel supply by the engagement of the external threads of the projecting part with the internal threads in the first end of the metal support.

13. A solid oxide fuel cell according to claim 12, wherein the projecting part comprises a supply through channel through which fuel is injected into the metal support.

14. A solid oxide fuel cell according to claim 13, wherein the supply channel has an intake diameter and an outlet diameter, the intake diameter being greater than the outlet diameter.

15. A solid oxide fuel cell according to claim 12, wherein the projecting part is metallic.

16. A solid oxide fuel cell according to claim 12, wherein the projecting part acts as a collector of the first electrode.

17. A solid oxide fuel cell according to claim 12, wherein the projecting part is insulated.

18. A solid oxide fuel cell according to claim 12, further comprising an evacuating system having an external structure, the second end of the tubular support being open and in communication with the evacuating system and attached to the external structure of the evacuating system, the external structure of the evacuating system comprises a projecting part having external threads and the second end of the metal support comprises internal threads, the second end of the metal support connected to the external structure of the evacuating system by the engagement of the external threads of the projecting part with the internal threads of the second end of the metal support.

19. A solid oxide fuel cell comprising:
a tubular metal support having an open first end and an open second end,
a first electrode deposited on the metal support,
an electrolyte deposited on the first electrode,
a second electrode deposited on the electrolyte,
a fuel supply having an external structure, the first end of the metal support in communication with the fuel supply and connected to the external structure of the fuel supply, and
an evacuating system having an external structure, the second end of the metal support in communication with the evacuating system and connected to the external structure of the evacuating system by threads.

20. A solid oxide fuel cell according to claim 19, wherein the first end of the metal support is attached by threads to the external structure of the fuel supply.

21. A solid oxide fuel cell according to claim 19, further comprising a first connection member having a first set of external threads and a second set of external threads, the second end of the metal support and the external structure of the evacuating system each having a set of internal threads, the first connection member attached to the external structure of the evacuating system by the engagement of the first set of external threads with the internal threads of the external structure of the evacuating system, the first connection member attached to the second end of the metal support by the engagement of the second set of threads with the internal threads in the second end of the metal support.

22. A solid oxide fuel cell according to claim 21, further comprising a second connection member having a threaded first segment having a first set of external threads and a threaded second segment having a second set of external threads, the first end of the metal support and the external structure of the fuel supply each having a set of internal threads, the second connection member attached to the external structure of the fuel supply by the engagement of the first set of external threads with the internal threads of the external structure of the fuel supply, the second connection member attached to the first end of the metal support by the engagement of the second set of threads with the internal threads in the first end of the metal support.

23. A solid oxide fuel cell according to claim 21, wherein the first connection member comprises a base on which the metal support is supported, the threaded first segment and threaded second segment each being continuous to the base.

24. A solid oxide fuel cell according to claim 21 wherein the first connection member is metallic.

25. A solid oxide fuel cell of according to claim 21, wherein the first connection member acts as a collector of the first electrode.

26. A solid oxide fuel cell according to claim 21, wherein the first connection member is insulated.

27. A solid oxide fuel stack comprising a plurality of solid oxide fuel cells, a fuel supply and an evacuating system, the solid oxide fuel cells comprising a tubular metal support, a first electrode deposited on the metal support, an electrolyte deposited on the first electrode and a second electrode deposited on the electrolyte, the fuel supply having an external structure, the evacuating system having an external structure, each tubular metal support having an open first end and an open second end, the first open end communicating with the fuel supply through respective openings in the external structure of the fuel supply and attached to the external structure by threads, the second open end communicating with the evacuating system through respective openings in the external structure and attached to the external structure by threads.
